(19) United States
(12) Patent Application Publication
(10) Pub. No.: US 2010/0247266 A1
(43) Pub. Date: Sep. 30, 2010

(54) Self-locking nut

(76) Inventor: Tadeusz Staniszewski, Hackettstown, NJ (US)

Correspondence Address: THOMAS J. GERMINARIO, ESQ., 154 ROUTE 206, CHESTER, NJ, 07930, US

(21) Appl. No.: 12/382,837

(22) Filed: Mar. 25, 2009

(51) Int. Cl. F16B 39/12

(52) U.S. Cl. 411/201

(57) ABSTRACT

A self-locking nut comprises a slotted nut and a locking nut and is assembled by complementary asymmetrical threading. After the locking nut is threaded onto the neck of the slotted nut, the assembled self-locking nut turns freely as it is threaded onto the shaft of a bolt. Once the forward face of the slotted nut contacts the material being fastened, additional turns clamp the material to the desired torque. Now, when additional torque is applied to the locking nut, its internal thread slides forward along the shallow incline of the asymmetrical external thread on the neck of the slotted nut, thereby exerting a compressive radial force on the slotted neck.

The compressive radial force contracts the slots of the slotted nut, thus constricting the circumference of the slotted nut around the bolt shaft. As the slotted nut constricts, the female crests of its internal threads are forced more tightly against the male crests of the external threads of the bolt shaft, thereby locking the female threads of the slotted neck to the male threads of the bolt. This produces a strong 360-degree mechanical metal-to-metal connection, and does not damage or deform the threads of the bolt.

### BACKGROUND OF THE INVENTION

The present invention relates to hardware fasteners with mating internal-external threads. More specifically the present invention relates to nut-and-bolt fasteners, and even more specifically to a self-locking, vibration resistant nut that compressively grips the threads of a bolt in a fixed position so that the bolt will not self-loosen as a result of vibration or rotational movement.

Known methods for locking a nut in position on a bolt involve the use of jam nuts, lock nuts, lock washers, spring washers and/or adhesives. These methods have the disadvantages of complexity in terms of multiple components and difficulty of assembly, which add time and expense to the installation. When these known methods are applied, moreover, the locked nut cannot be readily backed off and reused, which renders repair and maintenance more time-consuming and expensive.

The present invention addresses these deficiencies by providing a self-locking nut with a two-piece design comprising an inner slotted nut with a coaxially mounted outer locking nut. The slotted nut has internal symmetrical threads corresponding to the external threads on the shaft of a standard bolt of a given diameter. The slotted nut has a head, which is typically hexagonal, and a tubular slotted neck, which has external asymmetrical threads that correspond to internal asymmetrical threads of the locking nut.

A symmetrical thread is one in which both flanks of the thread profile are inclined at the same angle, while in an asymmetrical thread profile the opposing flanks are inclined at different angles. The self-locking nut of the present invention uses a forward asymmetrical thread, which is to say, a thread in which the flank in the direction that the nut tightens has a shallower incline than the flank in the direction that the nut backs off. The use of cooperating forward asymmetrical threaded components for mounting coaxially-bored machine elements on a shaft is disclosed in U.S. Pat. Nos. 6,000,875 and 5,067,846 issued to the inventor of the present invention, both of which are incorporated herein by reference.

### SUMMARY OF THE INVENTION

After the locking nut is threaded onto the neck of the slotted nut, the assembled self-locking nut turns freely as it is threaded onto the shaft of the bolt. Once the forward face of the slotted nut contacts the material being fastened, additional turns clamp the material to the desired torque. Now, when additional torque is applied to the locking nut, its internal thread slides forward along the shallow incline of the asymmetrical external thread on the neck of the slotted nut, thereby exerting a compressive radial force on the slotted neck.

The compressive radial force contracts the slot(s) of the slotted nut, thus constricting the circumference of the slotted nut around the bolt shaft. As the slotted nut constricts, the female crests of its internal threads are forced more tightly against the male crests of the external threads of the bolt shaft, thereby locking the female threads of the slotted neck to the male threads of the bolt. This produces a strong 360-degree mechanical metal-to-metal connection, and does not damage or deform the threads of the bolt.

The self-locking nut is easily removed by first backing off the locking nut ¼-¾ turns and then loosening the slotted nut. The self-locking nut will now turn freely for removal.

In an alternate embodiment, the forward face of the slotted nut can be provided with a flange by which the self-locking nut can also be pressed into a sheet metal frame to become a self-clinching lock-nut. In this mode, the bolt is first inserted into the slotted nut and tightened to the desired level. Then the lock nut is tightened asymmetrically on the slotted nut, causing it to constrict around the bolt shaft and lock it in place.

In this mode, the self-locking nut is permanently retained in an aluminum or soft steel sheet, providing load-bearing threads that afford a highly reliable method of blind fastening. The self-locking nut securely locks the bolt's threaded shaft against torques and makes the nut an integral part of the assembly.

### BRIEF DESCRIPTION OF THE DRAWINGS

FIG. 1 is a side perspective view of the unassembled components of the self-locking nut according to the preferred embodiment of the present invention;

FIG. 2 is an end perspective view of the assembled components of the self-locking nut according to the preferred embodiment of the present invention;

FIG. 3 is a half sectional view of the self-locking nut according to the preferred embodiment of the present invention, showing the self-locking nut turning freely on the threaded shaft of a bolt before the lock nut is fully tightened;

FIG. 4 is a half sectional view of the self-locking nut according to the preferred embodiment of the present invention, showing the self-locking nut locked onto the threaded shaft of a bolt after the lock nut has been fully tightened; and

FIG. 5 is a sectional view of the self-locking nut according to an alternate embodiment of the present invention, showing a flanged slotted nut mounted on a sheet metal frame.

### DETAILED DESCRIPTION OF THE PREFERRED EMBODIMENTS

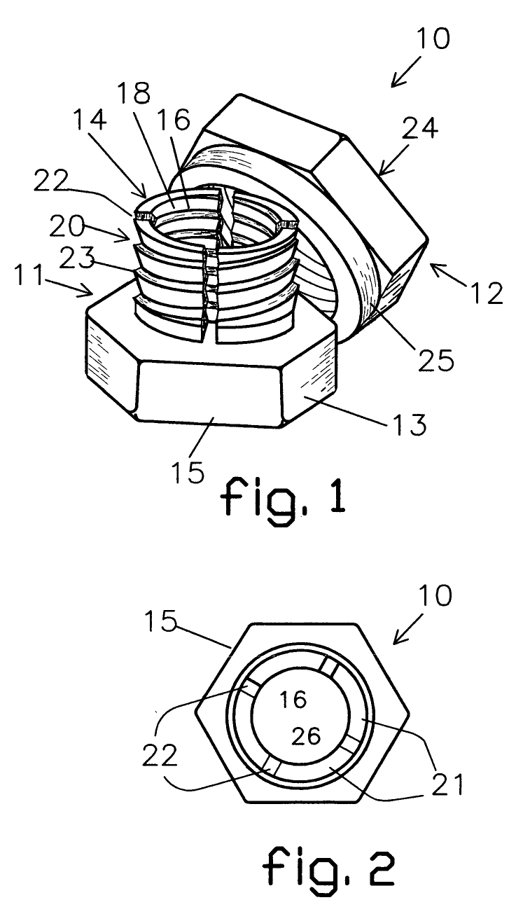

Referring to FIGS. 1 and 2, a self-locking nut according to the preferred embodiment of the present invention 10 comprises a slotted nut 11 and a lock nut 12. The slotted nut 11 comprises a head 13 and a neck 14. The head 13 has a polygonal border 15, which is typically hexagonal, encompassing an axially-aligned cylindrical central bore 16, which corresponds to the diameter of a standard threaded bolt 17. The central bore 16 extends through the neck 14 of the slotted nut 11 and is threaded with internal symmetrical threading 18 of the same pitch and handedness as external symmetrical threading 19 of the corresponding bolt 17. The neck 14 of the slotted nut 11 has a tubular sleeve 20 encompassing the central bore 16. The tubular sleeve 20 is divided into two or more sleeve segments 21 by one or more slots 22. The outer surface of the tubular sleeve 20 is threaded with external asymmetrical threading 23 with the same handedness as the internal symmetrical threading 18 of the central bore 16.

The lock nut 12 comprises a crown 24 and a stem 25. The crown 24 of the lock nut 12 preferably conforms to the shape and size of the head 13 of the slotted nut 11, so that the lock nut 12 and the slotted nut 11 can be turned together with a single tool. The stem 25 of the lock nut 12 is in the shape of a hollow cylinder with its circular perimeter circumscribed within the polygonal perimeter of the crown 24. Extending through the crown 24 and the stem 25 of the lock nut 12 is an axial bore 26, which matches the outer diameter of the neck 14 of the slotted nut 11. The axial bore 26 of the lock nut 12 is threaded with internal asymmetrical threading 27 which meshes with the external asymmetrical threading 23 of the slotted nut 11.

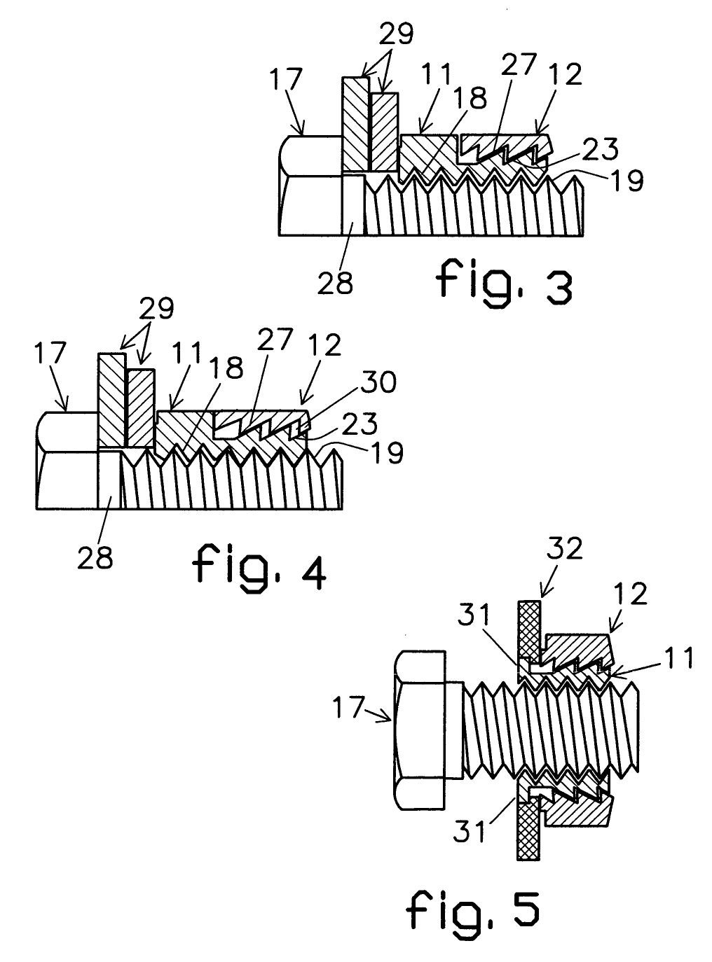

FIGS. 3 and 4 illustrate the operation of the self-locking nut 10. The lock nut 12 is first mounted on the slotted nut 11 by meshing the complementary asymmetrical threading 23 27 of the two components until the asymmetrical threads are fully engaged, as shown in FIG. 3. At this point, applying further tightening torque to the lock nut 12 will turn the entire assembled self-locking nut 10. The internal symmetrical threading 18 of the central bore 16 of the assembled self-locking nut 10 can now be meshed with the complementary external symmetrical threading 19 of the bolt 17. As further tightening torque is applied to the lock nut 12, the entire assembled self-locking nut 10 advances toward the shank 28 of the bolt 17 until the forward face of the head 13 of the slotted nut 11 engages the fastened material 29. At this point, as depicted in FIG. 3, the complementary symmetrical threading of the slotted nut 18 and the bolt 19 are aligned, but not engaged so as to lock the nut 10 in place.

When further tightening torque is applied to the lock nut 12, the internal asymmetrical threads 27 of the lock nut 12, slide along the external asymmetrical threads 23 of the slotted nut 11, as shown in FIG. 4. This sliding causes the asymmetrical threads 23 27 to disengage, such that gaps 30 open between the threads. The opening of the gaps 30 between the asymmetrical threads 23 27 reduces the clearance for the tubular sleeve 20 of the slotted nut 11 and thereby causes its slot(s) 22 to contract. As the sleeve segments 21 are forced closer together, the tubular sleeve 20 is compressively constricted around the threads 19 of the bolt 17, such that the complementary symmetrical threads 18 19 of the slotted nut 11 and the bolt 17 become lockingly engaged, as depicted in FIG. 4.

If modest loosening torque is afterward applied to the lock nut 12, its asymmetrical threads 27 will slide back into the position of being fully engaged with the complementary asymmetrical threads 23 of the slotted nut 11, thereby releasing the radial force on the tubular sleeve 20 and allowing its slot(s) to expand. As the sleeve segments 21 again spread apart, the constriction of the tubular sleeve 20 around the threads 19 of the bolt 17 is released, such that the complementary symmetrical threads 18 19 of the slotted nut 11 and the bolt 17 become unlocked, as depicted in FIG. 3. The self-locking nut 10 can now be backed off the bolt 17 and removed.

An alternate embodiment of the present invention is illustrated in FIG. 5. Here the slotted nut 11 has on its forward face a flange 31, by which it can be mounted on a sheet metal frame 32, with the unlocked lock nut 12 engaging the inner surface of the frame 32. A bolt 17 can then be tightened into the self-locking nut 10 and then locked in place by applying a tightening torque to the lock nut 12. In this embodiment, the self-locking nut 10 can be used for blind fastening.

Although preferred embodiments of the present invention have been disclosed for illustrative purposes, those skilled in the art will appreciate that many additions, modifications and substitutions are possible, without departing from the scope and spirit of the present invention as defined by the accompanying claims.

What is claimed is:

1. A self-locking nut comprising:
an inner slotted nut and an outer locking nut that is coaxially mountable thereon, wherein the slotted nut has one or more radial slot(s); and
wherein the slotted nut has internal symmetrical threads, which correspond to and complement external threads on a shaft of a bolt, and the slotted nut also has external asymmetrical threads, which correspond to and complement internal asymmetrical threads of the locking nut; and
wherein the self-locking nut is assembled in an unlocked configuration by mounting the locking nut on the slotted nut and by applying sufficient tightening torque to the locking nut to cause the corresponding internal asymmetrical threads of the locking nut and external asymmetrical threads of the slotted nut to become fully engaged; and
wherein the assembled self-locking nut is locked in position of the shaft of the bolt by applying additional tightening torque to the locking nut, which causes sliding of the internal asymmetrical threads of the locking nut relative to the corresponding external asymmetrical threads of the slotted nut, such that the corresponding asymmetrical threads partially disengage, causing gaps to open between the asymmetrical threads, thereby causing the locking nut to exert an inward radial force on the slotted nut and causing the slot(s) of the slotted nut to contract, such that the slotted nut becomes compressively constricted around the shaft of the bolt and the complementary symmetrical threads of the slotted nut and the bolt become lockingly engaged; and
wherein the assembled self-locking is unlocked from the shaft of the bolt by applying sufficient loosening torque to the locking nut to cause its asymmetrical threads to slide back into the unlocked configuration of being fully engaged with the complementary asymmetrical threads of the slotted nut, such that the inward radial force on the slotted nut is released and its slot(s) expand, thereby causing the complementary symmetrical threads of the slotted nut and the bolt to become unlocked.

2. The self-locking nut according to claim 1, wherein the slotted nut has a forward flange by which the assembled self-locking nut in the unlocked configuration is mounted in an aperture of a frame, such that the bolt can be inserted into the aperture and torqued to a desired position and then locked in that position by applying additional tightening torque to the locking nut.
